(19) United States
(12) Patent Application Publication
(10) Pub. No.: US 2019/0009195 A1
(43) Pub. Date: Jan. 10, 2019

(54) Portable Strainer Device

(71) Applicant: Matthew Brett Moore, Dallas, TX (US)

(72) Inventor: Matthew Brett Moore, Dallas, TX (US)

(21) Appl. No.: 15/643,841

(22) Filed: Jul. 7, 2017

(51) Int. Cl. B01D 35/027; F02M 37/22

(52) U.S. Cl. CPC B01D 35/0273; F02M 2037/228; F02M 37/22

(57) ABSTRACT

A portable strainer device that consists of a cylindrical housing (sleeve) that slips over the end of a fuel nozzle with a strainer inside the cylindrical filtration housing at the bottom end and wide outside circular lip at the top end of the cylindrical strainer housing. The lip is wide enough, so that it will not fall into a fuel tank. There is a lip inside the cylindrical housing (sleeve) at the bottom.

### BRIEF DESCRIPTION OF THE DRAWINGS

The invention is described by example with reference to the accompanying figures. The drawings are schematic in nature and are not drawn to scale. In the figures:

FIG. 1 illustrates the portable strainer device cylindrical housing (sleeve);

FIG. 2 illustrates the inside lip of the portable cylindrical housing (sleeve);

FIG. 3 illustrates the wide outside lip on the portable cylindrical housing (sleeve);

FIG. 4 illustrates the strainer and the exit end of the portable cylindrical housing (sleeve);

FIG. 5 illustrates the entrance end of the cylindrical housing (sleeve).

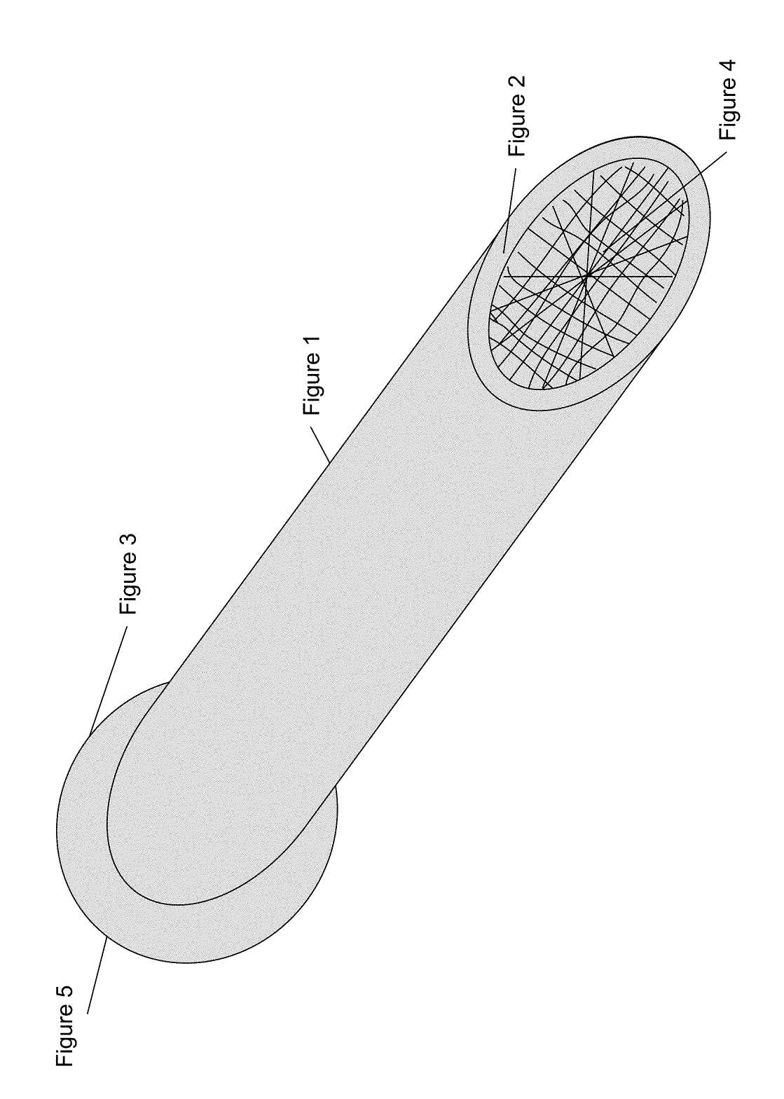

### BACKGROUND OF THE INVENTION

The invention concerns a portable strainer device, in particular for diesel/gasoline filling nozzles. The housing slides over the end of the fuel nozzle and will filter fuel via the strainer at the end of the cylindrical housing. The portable strainer device will not fall into a fuel tank because of the wide circular lip at the top of the cylindrical housing.

### SUMMARY OF THE INVENTION

The invention serves the purpose of a portable strainer device by simple means and of constructive materials, so fuel can be strained safely and quickly.

The cylindrical sleeve will fit simultaneously over a fuel dispenser and into a fuel tank. The fuel will travel through the cylindrical housing and be strained as it exits through the strainer before entering the fuel tank.

What is claimed is:

1. A portable strainer device that consists of a cylindrical housing (sleeve) that slips over the end of a fuel nozzle with a strainer inside the cylindrical filtration housing at the bottom end and wide outside circular lip at the top end of the cylindrical strainer housing. The lip is wide enough, so that it will not fall into a fuel tank. There is a lip inside the cylindrical housing (sleeve) at the bottom.

1. The portable strainer device according to claim 1, the cylindrical sleeve is wide enough so that it slides around a fuel dispenser and slender enough so that it will fit through the hole of a fuel tank.

2. The portable strainer device according to claim 2, wherein the strainer fits inside the bottom end of the cylindrical sleeve with an inside lip on the filtration housing.

3. The portable strainer device according to claim 3, wherein the cylindrical sleeve has a wide circular lip at the top end of the cylindrical housing (opposite end from from the strainer)¹
